(19) United States
(12) Patent Application Publication
(10) Pub. No.: US 2023/0243412 A1
(43) Pub. Date: Aug. 3, 2023

(54) APPARATUS, SYSTEM, AND METHODS FOR A CABLE TROLLEY DEVICE

(71) Applicant: Paul Budge, St. George, UT (US)

(72) Inventor: Paul Budge, St. George, UT (US)

(21) Appl. No.: 18/104,127

(22) Filed: Jan. 31, 2023

Related U.S. Application Data
(60) Provisional application No. 63/361,930, filed on Feb. 2, 2022.

(51) Int. Cl. F16H 55/50; B61B 7/00

(52) U.S. Cl. CPC F16H 55/50; B61B 7/00

(57) ABSTRACT

Apparatus, system, and methods for providing load responsive friction for a cable trolley device. An apparatus includes a housing configured to receive a cable. The housing includes a load attachment point and a friction device attached to the housing. The friction device is configured to cause deflection of the cable relative to an amount of load attached to the load attachment point.

### CROSS-REFERENCE TO RELATED APPLICATION

This application claims the benefit of U.S. Provisional Patent Application No. 63/361,930, filed Feb. 2, 2022, which is incorporated herein by reference.

### FIELD

This disclosure relates generally to roller wheel trolleys used to move people or materials down a cable or a zipline cable.

### BACKGROUND

The previously known cable trolleys have utilized roller wheels with friction pads, magnets, or other means to add friction to the wheels, or to the cable directly. These trolleys work moderately well at times, but in most cases they are inconsistent, have parts that wear out, or they do not control the friction properly based on weight. Some try to deal with excessive inertia from heavy riders or heavier material attached to the trolley by devising an arrest system at the end of the line. Arrest systems have to be reset properly for each rider.

### SUMMARY

The following is a non-exhaustive list of examples, which may or may not be claimed, of the subject matter, disclosed herein.

In one embodiment, an apparatus includes a housing configured to receive a cable. The housing includes a load attachment point and a friction device attached to the housing. The friction device is configured to cause deflection of the cable relative to an amount of load attached to the load attachment point.

In another embodiment, a system includes a cable and a housing configured to receive the cable. The housing includes a load attachment point and a friction device attached to the housing. The friction device is configured to cause deflection of the cable relative to an amount of load attached to the load attachment point.

In still another embodiment, a system includes a cable and a housing configured to receive the cable. The housing includes a load attachment point and a friction device attached to the housing and configured to cause deflection of the cable relative to an amount of load attached to the load attachment point. The friction device includes a first pulley having a first shaft, a second pulley having a second shaft, a pulley arm attached at a first section to the housing, at a second section to the first shaft, and at a third section to the second shaft, an adjustable attachment device configured to adjustably locate where on the first section of the pulley arm to attach the pulley arm to the housing; and a rotation friction adjusting device configured to change an amount of biasing of rotational force a load applies to the housing about the first shaft. The cable is received between the first pulley and the second pulley.

Embodiments disclosed here can provide a more constant speed for all materials or riders, regardless of their weight. By properly controlling speed, lighter materials or riders will not get stuck on the zipline before a landing platform, and heavier materials or riders will not come into the arrest system with too much speed and force to overwhelm the arrest system being utilized.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a side view of a cable trolley system, according to one or more examples of the present disclosure;

FIG. 2 is a perspective view of a cable trolley, according to one or more examples of the present disclosure;

FIG. 3 is an x-ray view of components of the cable trolley of FIG. 2, according to one or more examples of the present disclosure; and

FIG. 4 is an x-ray view of components of the cable trolley of FIG. 2, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

In various embodiments, examples of a cable trolley system, described herein, do not cause friction where of parts of as these examples do not include friction pads or magnets and thus do not produce concentrated heat in the trolley system or the trolley parts.

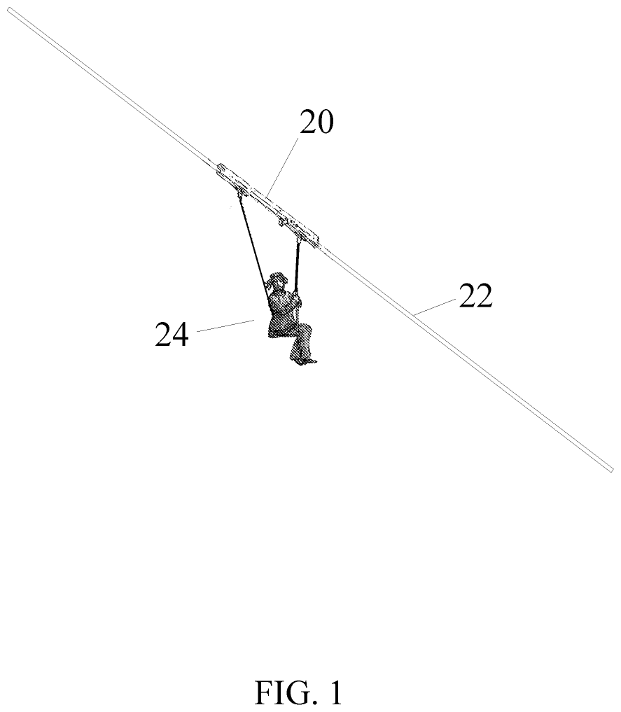

In various embodiments, as shown in FIG. 1, a trolley device 20 is slidably received on the cable 22. The trolley device 20 supports a hanging load 24 (e.g., a rider or materials). The weight of the load 24 causes components of the trolley device 20 to deform the cable 22, thus producing friction/resistance to gravitational forces of the load 24.

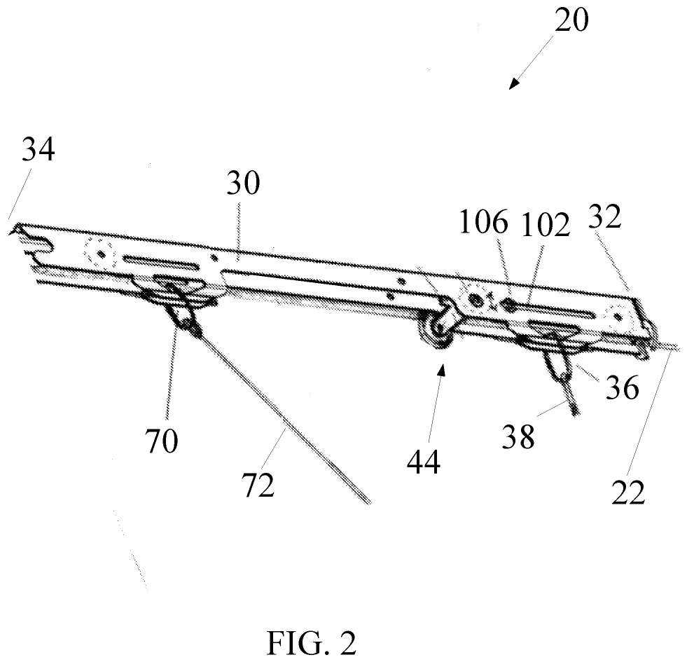

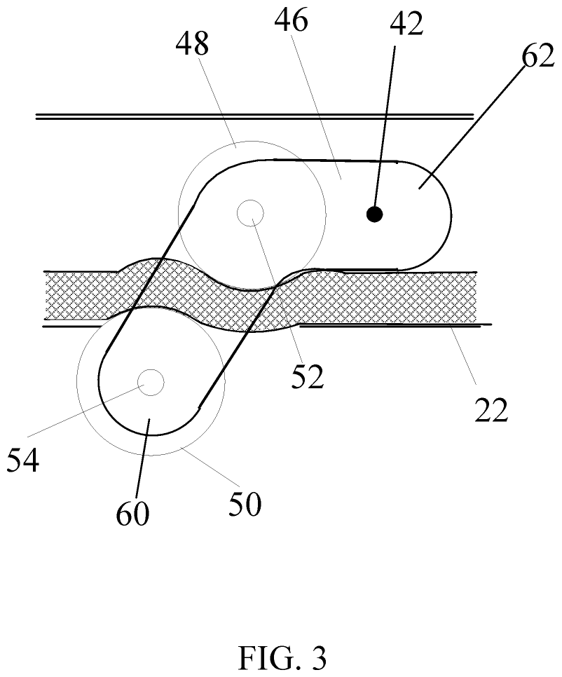

In various embodiments, referring to FIGS. 2 and 3, the trolley device 20 includes a housing 30 that receives the cable 22. The housing 30 includes a proximal end 32 and a distal end 34. The housing 30 includes a load attachment point 36 and a primary pulley system 44 located distal to the load attachment point 36. A load line 38 attaches the load 24 to the load attachment point 36. The primary pulley system 44 includes a pulley arm 46 that rotatably mounts to a shaft 52 of a proximal pulley 48. The shaft 52 is mounted to the housing 30. The pulley arm 46 includes a distal section 60 and a proximal section 62. The distal section 60 receives a shaft 54 of a distal pulley 50. The smallest angle between a line formed by the shaft 52 and the shaft 54 and a centerline of the housing 30 is an acute angle. The proximal section 62 is attached to the housing via an arm attachment point 42 that is proximal from the shaft 52. The housing 30 is open at a bottom section to allow for extension and rotation of the distal section of the pulley arm 46. The cable 22 is received within the housing 30 between the proximal pulley 48 and the distal pulley 50. The cable 22 supports the proximal pulley 48 that is carrying the weight of the load 24. Because the load attachment point 36 is located longitudinally near the arm attachment point 42, any weight/load applied to the load attachment point 36 will cause the pulley arm 46 and the housing 30 to rotate/pivot about the shaft 52, thereby causing the proximal pulley 48 and the distal pulley 50 to warp the cable 22. The amount of warp of the cable 22 is based on the amount of the load 24, the distance between the attachment point 42, the shaft 52, and the load attachment point 36.

The rotation causes the cable 22 to alter its path around the pulleys 48 and 50 in a wave shape. Heavier loads (materials or riders) will cause the cable 22 to deform more than lighter loads. In some examples, heavier zipline riders will cause more pronounced temporary deformation of the cable 22, thus producing more friction and ultimately more resistance to the two pulleys 48 and 50 rolling down in the cable 22.

In various embodiments, referring to FIG. 2, the housing 30 is extended in length distally to include a secondary emergency tether point 70 that receives an emergency tether line 72 that also connects to the load 24. The emergency tether line 72 prevents the load 24 from swinging upward and hitting the cable 22 or hitting portions of an arrest system. The housing 30 may extend proximally with the tether point located proximal from the primary pulley system 44. The emergency tether line 72 may also be made of an energy absorbing material as well to further absorb force when stopping forces are transferred upward under sudden braking conditions.

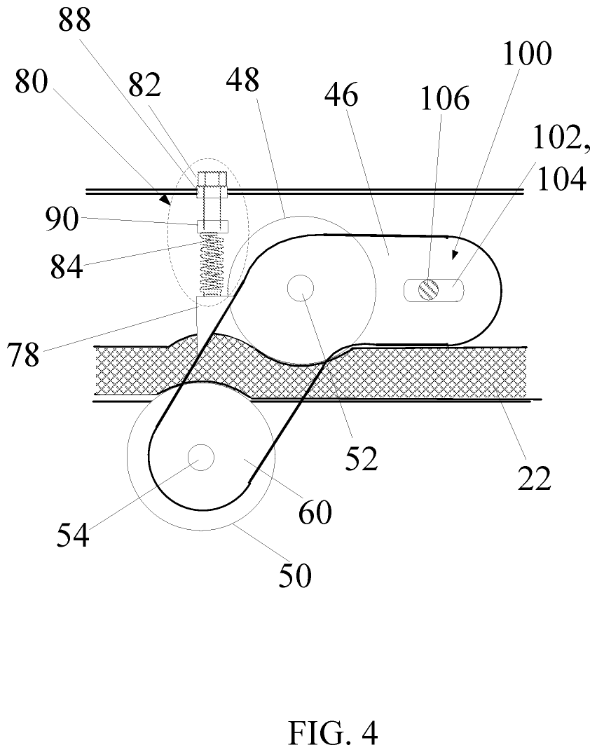

In various embodiments, referring to FIG. 4, a friction adjuster 80 is included in the housing 30. The friction adjuster 80 includes a bolt 82 that mounts through a wall of the housing 30. A nut 88 or 90 is positioned on the bolt 82 within the housing 30 or within the wall of the housing 30. A spring (or comparable biasing device) 84 is received over the bolt 82 between the nut 88 and a flange surface 78 that extends from the distal section 60 of the pulley arm 46. The flange surface 78 includes a thru hole sized to receive the bolt 82 but not the spring 84. Rotation of the bolt 82 relative to the nut 88, 90 decreases or expands the distance between the flange surface 78 and the nut 88, 90, thereby changing space available for the spring 84. Thus, when the pulley arm 46 rotates due to the load 24, the flange surface 78 contacts the spring 84 but not the bolt 82, thereby compressing the spring 84 between the nut 88 or 90 and the flange surface 78. The friction adjuster 80 may be adjusted to be more or less resistive to rotation of the pulley arm 46. In the case of the load 24 being light, the bolt 82/spring 84 may be adjusted to be more resistive, thereby limiting rotation of the pulley arm 46 and causing less deformation of the cable 22.

In various embodiments, still referring to FIG. 4, the housing 30 may include a force adjuster 100 for adjusting leverage/force applied to the cable 22 by the load 24. The force adjuster 100 includes longitudinal slots 102 in the housing 30, a longitudinal slot 104 in the proximal section 62 of the pulley arm 46, and an adjustable force bolt 106 mounted through the longitudinal slots 102 and 104 and adjustably attachable to at least the longitudinal slots 102 of the housing 30. The adjustable force bolt 106 may be moved to any location within the longitudinal slots 102, 104 by loosening the adjustable force bolt 106 from the longitudinal slots 102 of the housing 30, sliding the adjustable force bolt 106 to a desired location, and reattaching the adjustable force bolt 106 to the longitudinal slots 102 of the housing 30. The further away the adjustable force bolt 106 is located from the shaft 52 of the distal pulley 50 the load 24, the greater the rotational force the load 24 will apply to the pulley arm 46 and thus the cable 22.

### Embodiments

A. An apparatus comprising: a housing configured to receive a cable, the housing comprising: a load attachment point; and a friction device attached to the housing and configured to cause deflection of the cable relative to an amount of load attached to the load attachment point.

B. The apparatus of A, wherein the friction device comprises: a first pulley having a first shaft; a second pulley having a second shaft; and a pulley arm attached at a first end to the housing and at a second end to the first shaft, wherein the cable is received between the first pulley and the second pulley.

C. The apparatus of B, wherein an axis between the first shaft and the second shaft is not parallel with an axis between the first shaft and the first end of the pulley arm.

D. The apparatus of C, wherein the first pulley is disposed closer to a proximal end of the housing than the second pulley.

E. The apparatus of C, wherein the first pulley is disposed closer to a distal end of the housing than the second pulley.

F. The apparatus of any of B-E, wherein the friction device comprises: an adjustable attachment device configured to be adjustably attachable to different distances on the housing from the first shaft.

G. The apparatus of any of B-F, wherein the load attachment point is located on the housing relative to the first end, wherein when a load applied to the load attachment point the friction device is configured to produce a rotational force of the housing about the first shaft.

H. The apparatus of G, wherein the housing further comprises: a rotation friction adjusting device configured to change an amount of rotational force a load applies to the housing about the first shaft.

I. The apparatus of H, wherein the rotation friction adjusting device comprises: an adjustable biasing device configured to provide alterable resistance to rotational forces of the housing about the first shaft.

J. The apparatus of any of B-I, wherein a load applied to the first end of the pulley arm is configured to rotate the housing, the pulley arm, and the second pulley about the first shaft, thereby deflecting a longitudinal axis of the cable.

K. A system comprising: a cable; and a housing configured to receive the cable, the housing comprising: a load attachment point; and a friction device attached to the housing and configured to cause deflection of the cable relative to an amount of load attached to the load attachment point.

L. The system of K, wherein the friction device comprises: a first pulley having a first shaft; a second pulley having a second shaft; and a pulley arm attached at a first end to the housing and at a second end to the first shaft, wherein the cable is received between the first pulley and the second pulley.

M. The system of L, wherein an axis between the first shaft and the second shaft is not parallel with an axis between the first shaft and the first end of the pulley arm.

N. The system of M, wherein the first pulley is disposed closer to a proximal end of the housing than the second pulley.

O. The system of M, wherein the first pulley is disposed closer to a distal end of the housing than the second pulley.

P. The system of L, wherein the friction device comprises an adjustable attachment device configured to be adjustably attachable to different distances on the housing from the first shaft.

Q. The system of L, wherein the load attachment point is located on the housing relative to the first end, wherein when a load applied to the load attachment point the friction device is configured to produce a rotational force of the housing about the first shaft.

R. The system of L, wherein the housing further comprises a rotation friction adjusting device configured to change an amount of rotational force a load applies to the housing about the first shaft.

S. The system of claim 18, wherein the rotation friction adjusting device comprises an adjustable biasing device configured to provide alterable resistance to rotational forces of the housing about the first shaft.

T. The system of any of L-S, wherein a load applied to the first end of the pulley arm is configured to rotate the housing, the pulley arm, and the second pulley about the first shaft, thereby deflecting a longitudinal axis of the cable.

U. A system comprising: a cable; and a housing configured to receive the cable, the housing comprising: a load attachment point; and a friction device attached to the housing and configured to cause deflection of the cable relative to an amount of load attached to the load attachment point, the friction device comprising: a first pulley having a first shaft; a second pulley having a second shaft; a pulley arm attached at a first section to the housing, at a second section to the first shaft, and at a third section to the second shaft, wherein the cable is received between the first pulley and the second pulley; an adjustable attachment device configured to adjustably locate where on the first section of the pulley arm to attach the pulley arm to the housing; and a rotation friction adjusting device configured to change an amount of biasing of rotational force a load applies to the housing about the first shaft.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus comprising:
a housing configured to receive a cable, the housing comprising:
a load attachment point; and
a friction device attached to the housing and configured to cause deflection of the cable relative to an amount of load attached to the load attachment point.

2. The apparatus of claim 1, wherein the friction device comprises:
a first pulley having a first shaft;
a second pulley having a second shaft; and
a pulley arm attached at a first end to the housing and at a second end to the first shaft,
wherein the cable is received between the first pulley and the second pulley.

3. The apparatus of claim 2, wherein an axis between the first shaft and the second shaft is not parallel with an axis between the first shaft and the first end of the pulley arm.

4. The apparatus of claim 3, wherein the first pulley is disposed closer to a proximal end of the housing than the second pulley.

5. The apparatus of claim 3, wherein the first pulley is disposed closer to a distal end of the housing than the second pulley.

6. The apparatus of claim 2, wherein the friction device comprises an adjustable attachment device configured to adjustably locate where on the first end of the pulley arm to attach to the housing the first shaft.

7. The apparatus of claim 2, wherein the load attachment point is located on the housing relative to the first end, wherein when a load applied to the load attachment point the friction device is configured to produce a rotational force of the housing about the first shaft.

8. The apparatus of claim 7, wherein the housing further comprises a rotation friction adjusting device configured to change an amount of rotational force a load applies to the housing about the first shaft.

9. The apparatus of claim 8, wherein the rotation friction adjusting device comprises an adjustable biasing device configured to provide alterable resistance to rotational forces of the housing about the first shaft.

10. The apparatus of claim 2, wherein a load applied to the first end of the pulley arm is configured to rotate the housing, the pulley arm, and the second pulley about the first shaft, thereby deflecting a longitudinal axis of the cable.

11. A system comprising:
a cable; and
a housing configured to receive the cable, the housing comprising:
a load attachment point; and
a friction device attached to the housing and configured to cause deflection of the cable relative to an amount of load attached to the load attachment point.

12. The system of claim 11, wherein the friction device comprises:
a first pulley having a first shaft;
a second pulley having a second shaft; and
a pulley arm attached at a first end to the housing and at a second end to the first shaft,
wherein the cable is received between the first pulley and the second pulley.

13. The system of claim 12, wherein an axis between the first shaft and the second shaft is not parallel with an axis between the first shaft and the first end of the pulley arm.

14. The system of claim 13, wherein the first pulley is disposed closer to a proximal end of the housing than the second pulley.

15. The system of claim 13, wherein the first pulley is disposed closer to a distal end of the housing than the second pulley.

16. The system of claim 12, wherein the friction device comprises an adjustable attachment device configured to adjustably locate where on the first end of the pulley arm to attach to the housing the first shaft.

17. The system of claim 12, wherein the load attachment point is located on the housing relative to the first end, wherein when a load is applied to the load attachment point the friction device is configured to produce a rotational force of the housing about the first shaft.

18. The system of claim 12, wherein the housing further comprises a rotation friction adjusting device configured to change an amount of rotational force a load applies to the housing about the first shaft.

19. The system of claim 18, wherein the rotation friction adjusting device comprises an adjustable biasing device configured to provide alterable resistance to rotational forces of the housing about the first shaft.

20. A system comprising:
a cable; and
a housing configured to receive the cable, the housing comprising:
a load attachment point; and
a friction device attached to the housing and configured to cause deflection of the cable relative to an amount of load attached to the load attachment point, the friction device comprising:
a first pulley having a first shaft;
a second pulley having a second shaft;
a pulley arm attached at a first section to the housing, at a second section to the first shaft, and at a third section to the second shaft, wherein the cable is received between the first pulley and the second pulley;
an adjustable attachment device configured to adjustably locate where on the first section of the pulley arm to attach the pulley arm to the housing; and
a rotation friction adjusting device configured to change an amount of biasing of rotational force a load applies to the housing about the first shaft.
